(19) United States
(12) Patent Application Publication
(10) Pub. No.: US 2010/0103128 A1
(43) Pub. Date: Apr. 29, 2010

(54) ELECTRONIC DEVICE AND TOUCH CONTROL METHOD THEREOF

(75) Inventors: Hao-Ying Chang, Taipei City (TW); Jui-Tsen Huang, Taipei City (TW); Da-Yu Yu, Taipei City (TW); Ching-Fu Yang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 12/558,587

(22) Filed: Sep. 14, 2009

Related U.S. Application Data
(60) Provisional application No. 61/108,028, filed on Oct. 24, 2008.

(51) Int. Cl. G06F 3/041

(52) U.S. Cl. 345/173

(57) ABSTRACT

An electronic device and a touch control method thereof are provided. The electronic device has a touch unit, a press unit and a processing module. The press unit is disposed under the touch unit, and is used for generating a pressing signal. The processing module is electrically connected with the touch unit and press unit. When the processing module receives the pressing signal, an area of the touch unit is transformed into a pressing area.

### CROSS-REFERENCE TO RELATED APPLICATION

This application claims the priority benefit of U.S. provisional application Ser. No. 61/108,028, filed on Oct. 24, 2008. The entirety of the above-mentioned patent application is hereby incorporated by reference herein and made a part of specification.

### BACKGROUND OF THE INVENTION

1. Field of the Invention

The present invention relates to an electronic device and a touch control method thereof. More particularly, the present invention relates to an electronic device having a touch unit, and a touch control method thereof.

2. Description of Related Art

In an electronic device, a human-machine interface is generally used to receive external commands, so that the electronic device can execute corresponding operations according to the received external commands. In other words, a user can control the electronic device to execute different functions through the human-machine interface. For example, the human-machine interface of a commonly used notebook computer includes a touch unit, a keyboard and a mouse. The user inputs characters through the keyboard, or moves a cursor to a designated location through the mouse or the touch unit, so as to select an icon or a file, etc. Therefore, the user can communicate with a system unit in the electronic device through the human-machine interface.

Generally, a press unit is configured at an adjacent side of the touch unit, and the press unit includes a left key and a right key, and functions of the left key and the right key of the press unit are the same to that of a left key and a right key of the mouse. However, a sensing area of the touch unit and a pressing area of the press unit are all configured on a case surface of the notebook computer, so that the press unit occupies a configuration space of the touch unit.

### SUMMARY OF THE INVENTION

The present invention is directed to an electronic device and a touch control method thereof, in which when a pressing signal of a press unit is received, an area of a touch unit above the press unit is transformed into a pressing area.

The present invention is directed to an electronic device and a touch control method thereof, in which a press unit is configured below a touch unit, so that the press unit does not occupies a configuration space of the touch unit.

The present invention provides a touch control method adapted to an electronic device including a processing module, a touch unit, and a press unit disposed under the touch unit. The touch control method includes following steps. First, an area of the touch unit is pressed to trigger the press unit to generate a pressing signal. Next, when the processing module receives the pressing signal, the area of the touch unit is transformed into a pressing area.

In an embodiment of the present invention, when the processing module receives the pressing signal, the processing module divides the touch unit into a sensing area and the pressing area, wherein the sensing area of the touch unit is capable of being actuated by a touch operation, and the pressing area of the touch unit is incapable of being actuated by the touch operation.

In an embodiment of the present invention, the processing module has a determining unit, which is used for determining whether the processing module receives the pressing signal.

In an embodiment of the present invention, when the processing module does not receive the pressing signal, the processing module receives a first sensing signal of the touch unit to generate a first cursor control signal.

In an embodiment of the present invention, the processing module receives the pressing signal to generate a second cursor control signal.

In an embodiment of the present invention, the processing module receives the pressing signal and a second sensing signal of the sensing area to generate a third cursor control signal.

In an embodiment of the present invention, the touch unit has a first module and a second module, wherein the first module is disposed corresponding to the pressing area, and the second module is disposed corresponding to the sensing area, and when the processing module receives the pressing signal, only the second module is capable of being actuated by a touch operation.

In an embodiment of the present invention, when the processing module does not receive the pressing signal, the processing module receives a third sensing signal of the first module or a fourth sensing signal of the second module to generate a first cursor control signal.

In an embodiment of the present invention, the processing module receives the pressing signal and the fourth sensing signal of the second module to generate a third cursor control signal.

In an embodiment of the present invention, the area of the touch unit is disposed corresponding to the press unit.

The present invention provides an electronic device including a touch unit, a press unit and a processing module. The press unit is disposed under the touch unit, and is used for generating a pressing signal. The processing module is electrically connected with the touch unit and the press unit. When the processing module receives the pressing signal, an area of the touch unit is transformed into a pressing area.

According to the electronic device and the touch control method of the present invention, when the processing module receives the pressing signal, an area of the touch unit is transformed into a pressing area, and since the pressing area cannot be actuated by the touch operation, a cursor control is not influenced. Moreover, the sensing area and the pressing area can be preset on the touch unit, or the first module and the second module corresponding to the pressing area and the sensing area are respectively configured on the touch unit. By such means, when the pressing signal is not received, a full region of the touch unit can sense the touch operation to generate the sensing signal. When the pressing signal is received, an area of the touch unit is transformed into the pressing area, and the pressing area cannot be actuated by the touch operation, while only the sensing area can be actuated by the touch operation. Compared to a conventional technique, application of a high-order multi-point touch unit and a high-order operation processing module is unnecessary, and changing of circuit designs of the touch unit and the processing module is also unnecessary, so that a production cost thereof can be reduced. Moreover, the pressing unit is disposed under the touch unit, so that the press unit does not occupy a configuration space of the touch unit.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is schematic diagram illustrating an appearance of an electronic device according to an embodiment of the present invention.

FIG. 1B is a block diagram of an electronic device of FIG. 1A.

FIG. 1C is a flowchart illustrating a touch control method according to an embodiment of the present invention.

FIG. 2A is a block diagram of an electronic device according to another embodiment of the present invention.

FIG. 2B is a flowchart illustrating a touch control method according to another embodiment of the present invention.

### DESCRIPTION OF THE EMBODIMENTS

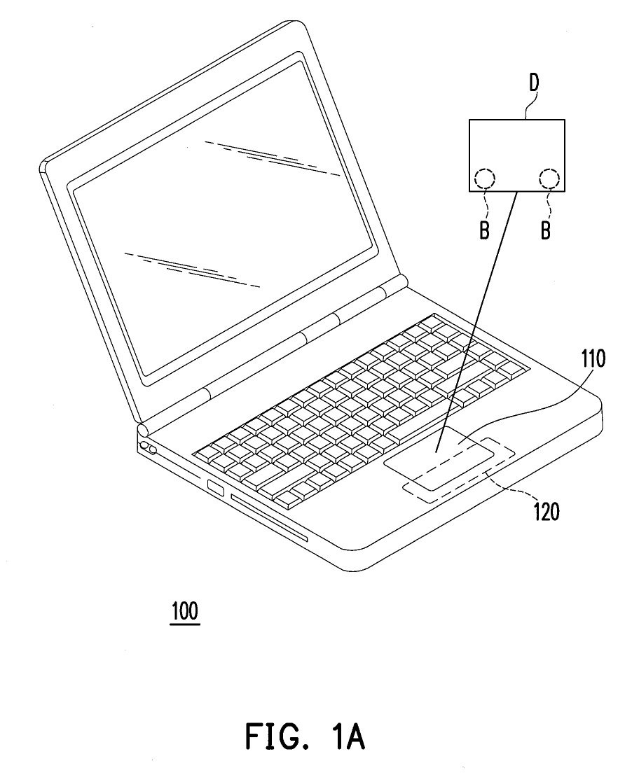

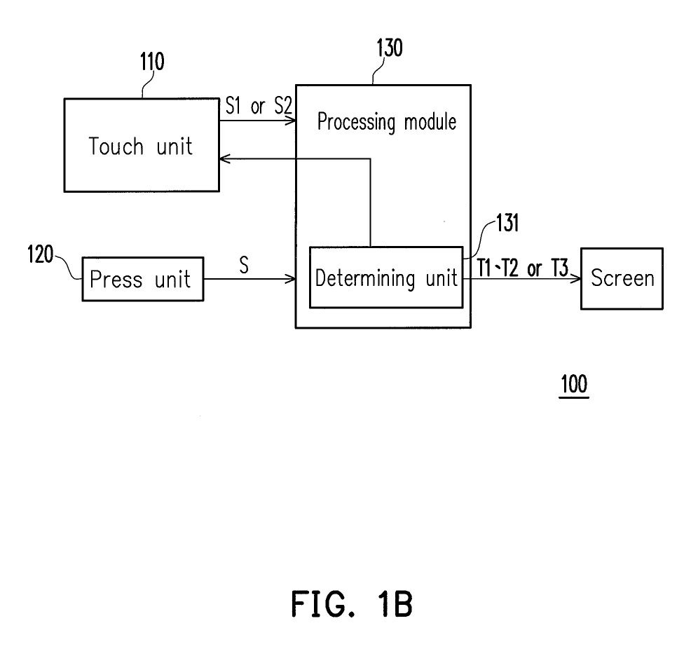

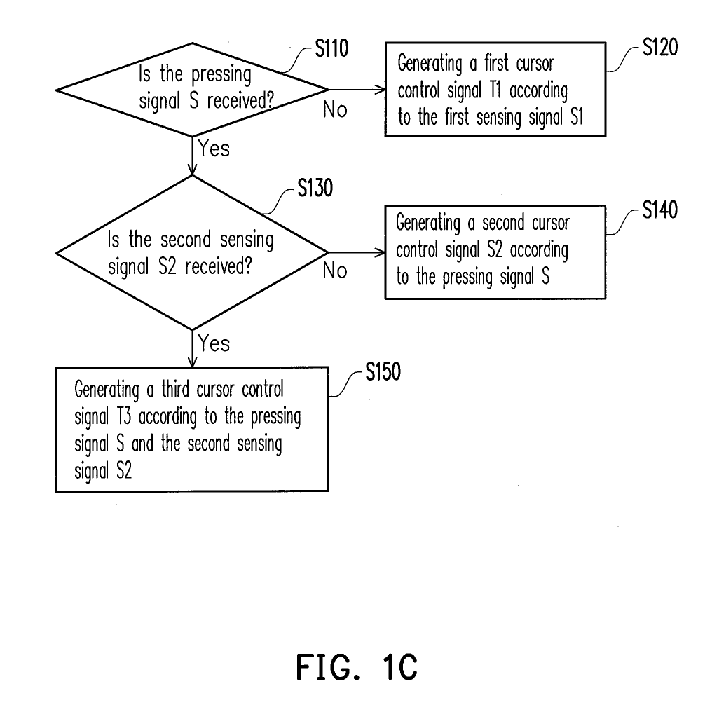

FIG. 1A is schematic diagram illustrating an appearance of an electronic device according to an embodiment of the present invention, and FIG. 1B is a block diagram of the electronic device of FIG. 1A. FIG. 1C is a flowchart illustrating a touch control method according to an embodiment of the present invention. In the present embodiment, the electronic device 100 is, for example, a notebook computer having a touch unit 110 and a press unit 120, so that the electronic device 100 can execute corresponding operations according to the received external commands. A user can drive a cursor to a designated location by operating the touch unit 110 and the press unit 120, so as to select an icon or open a file, etc. Therefore, the user can communicate with a processing module 130 in the electronic device 100 through the touch unit 110 and the press unit 120. An internal system and an operation flow of the electronic device 100 are described in detail below.

Referring to FIG. 1A and FIG. 1B, the electronic device 100 includes the touch unit 110, the press unit 120 and the processing module 130. The press unit 120 is disposed under the touch unit 110, and the press unit 120 can be pressed to generate a pressing signal S. The processing module 130 is electrically connected to the touch unit 110 and the press unit 120.

In the present embodiment, the press unit 120 has two press portions (not shown), and the press portions are respectively disposed under two corner region of the touch unit 110. Moreover, each press portion can be a mechanical switch or a piezoelectric switch, and functions of the two press portions are the same to that of a left key and a right key of a mouse. Certainly, the structures, the functions and a quantity of the press portions can be changed according to actual design requirement, which is not limited by the present invention.

Since the press unit 120 is disposed under the touch unit 110, and is not disposed at an adjacent side of the touch unit 110. In view of an appearance, the user can only see the touch unit 110 disposed on a case of the electronic device 100, and cannot see the press unit 120. A purpose of such configuration is to avoid the press unit 120 occupying a configuration space of the touch unit 110.

When the user presses the touch unit 110 by applying an enough pressure, the touch unit 110 sustains the pressure, and one of the press portions of the press unit 120 is triggered to generate the pressing signal S. Now, the processing module 130 receives the pressing signal S, and transforms an area of the touch unit 110 above the press unit 120 into a pressing area B, wherein the pressing area B, in this embodiment, is disposed corresponding to a position wherein the touch unit 110 is pressed. Of course, the pressing area B may be disposed not corresponding to the touch unit 110. The user can press an area of the touch unit 110 not corresponding to the press unit 120, and the touch unit 110 is pressed to tilt or deform and to touch the press unit 120 for generating the pressing signal S. Meanwhile, the processing module 130 also receives the pressing signal S so that the area of the touch unit 110 not corresponding to the press unit 120 is transformed into the pressing area B.

Moreover, the processing module 130 has a determining unit 131, which is used for determining whether the processing module 130 receives the pressing signal S.

If the determining unit 131 determines that the processing module 130 does not receive the pressing signal S, it represents that the user only touches the touch unit 110 without applying the enough pressure to press the touch unit 110, so that the press unit 120 is not triggered to generate the pressing signal S. Now, when a finger of the user moves on the touch unit 110, the touch unit 110 generates a first sensing signal S1 according to a moving variation of a touch position.

If the determining unit 131 determines that the processing module 130 receives the pressing signal S, the processing module 130 divides the touch unit 110 into a pressing area B and a sensing area D. Now, the sensing area D can be actuated by a touch operation, and the pressing area B cannot be actuated by the touch operation. When the user presses the touch unit 110 (the pressing area B), the user can simultaneously touches the sensing area D, and the touch unit 110 generates a second sensing signal S2 according to a moving variation of a touch position on the sensing area D.

It should be noticed that in the present embodiment, the pressing area B is preset at a corner region of the touch unit 110, and the other region of the touch unit 110 is the sensing area D. Since a location of the pressing area B is configured corresponding to a pressed area of the touch unit 110 above the press unit 120, the location and a quantity of the pressing area. B can be determined according to the position and the quantity of the press portions of the press unit 120.

Referring to steps S110-S150 of FIG. 1C, FIG. 1C is a flowchart illustrating a touch control method according to an embodiment of the present invention.

First, in step S110, the processing module 130 determines whether the pressing signal S is received. Now, the determining unit 131 of the processing module 130 determines whether the pressing signal S of the press unit 120 is received, if not, the step S120 is executed, and if yes, the step S130 is executed.

In the step S120, since the user only touches the touch unit 110 without applying an enough pressure, the press unit 120 is not triggered to generate the pressing signal S. Now, the user touches the touch unit 110 and moves his/her finger, and the touch unit 110 generates the first sensing signal S1 according to the moving variation of the touch position, and the processing module 130 receives the first sensing signal S1 to generate a first cursor control signal T1. For example, the first cursor control signal T1 can be a cursor direction control signal, which is used for controlling a cursor on a screen to move upwards, downwards, leftwards and rightwards, etc. Certainly, the function of the first cursor control signal T1 can also be determined according to an actual demand.

In the step S130, the processing module 130 determines whether the second sensing signal S2 of the touch unit 110 is received, if not, the step S140 is executed, and if yes, the step 150 is executed.

In the step S140, the processing module 130 receives the pressing signal S, and now the touch unit 110 is divided into the pressing area B and the sensing area D, wherein the pressing area B cannot be actuated by the touch operation, and the sensing area D can be actuated by the touch operation. When the processing module 130 does not receive the second sensing signal S2, it represents that the user only presses the touch unit 110 (the pressing area B) to simply perform a press operation. Therefore, the processing module 130 receives the pressing signal S and generates a second cursor control signal T2. In the present embodiment, the second cursor control signal T2 can be a left key function signal or a right key function signal of a mouse, though the present invention is not limited thereto.

In step S150, when the processing module 130 receives the second sensing signal S2, it represents that after the user presses the touch unit 110, the user again touches the sensing area D of the touch unit 110. Therefore, the processing module 130 receives the pressing signal S and the second sensing signal S2 generated by the sensing area D to generate a third cursor control signal T3. For example, the third cursor control signal T3 can be a window selecting signal. The user can first press the pressing area B located at the lower-left corner of the touch unit 110 to trigger the press unit 120 sending the pressing signal S, so as to execute a press operation corresponding to, for example, the left key function of the mouse. Then, the user continually presses the pressing area B and touches the sensing area D of the touch unit 110, and moves his/her finger on the sensing area D to generate the second sensing signal S2. By such means, the user can perform a window selecting operation on the screen.

According to the above descriptions, the processing module 130 determines whether the pressing signal S is received, and if yes, the touch unit 110 is divided into the pressing area B and the sensing area D. In an actual application, when the touch unit 110 is not pressed, and accordingly the pressing signal S is not generated, the processing module 130 processes the first sensing signal of a full region of the touch unit 110, and transforms the first sensing signal S1 into the first cursor signal T1. When the touch unit 110 is pressed to generate the pressing signal S, the touch unit 110 is divided into the pressing area B and the sensing area D. Now, the sensing area D can be actuated by the touch operation, and the pressing area B cannot be actuated by the touch operation. Therefore, the processing module 130 processes the pressing signal S to determine the press operation, so as to execute the press operation corresponding to, for example, the left key function, the right key function of the mouse, or other predetermined functions. Alternatively, the user presses the touch unit 110 and simultaneously touches the sensing area D, the processing module 130 then receives the pressing signal S and the second sensing signal S2 of the sensing area D to generate the third cursor control signal T3. By such means, the user can control the cursor to perform, for example, the window selecting operation.

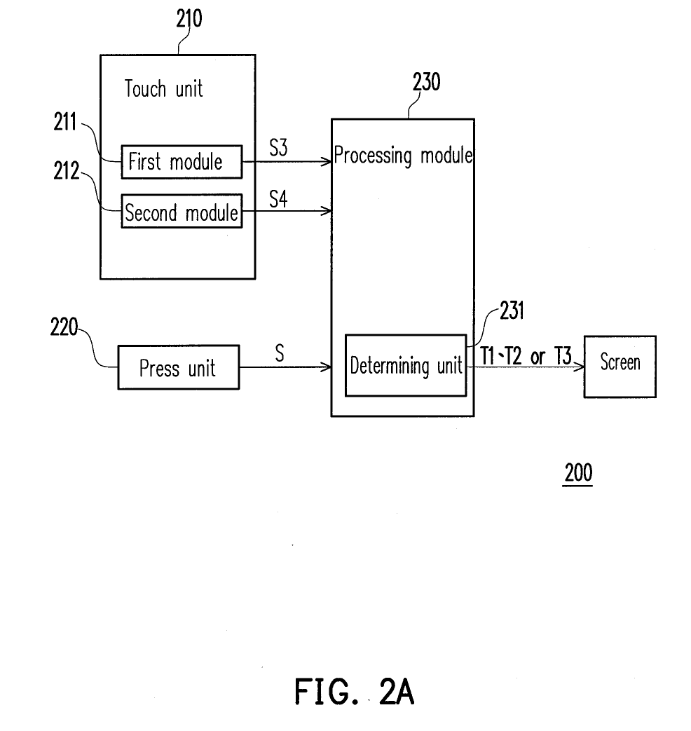

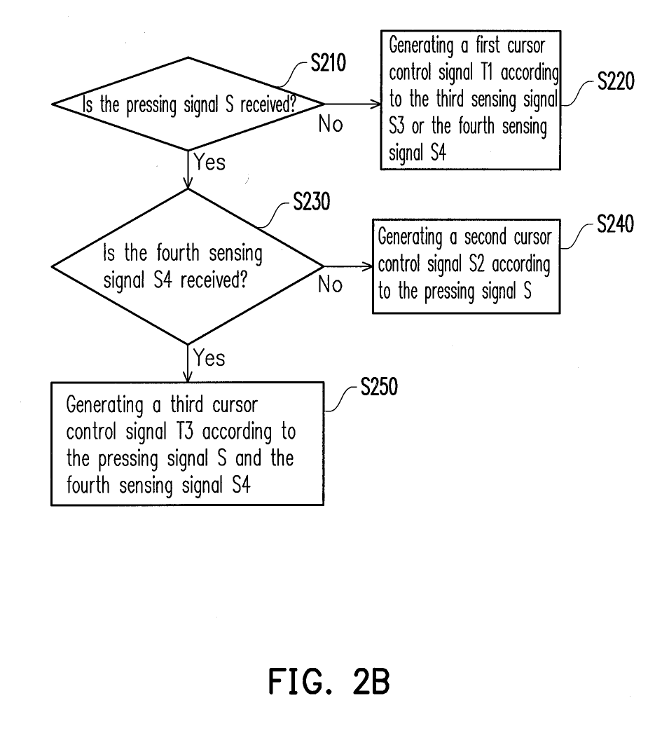

Next, referring to FIG. 2A and FIG. 2B, FIG. 2A is a block diagram of an electronic device according to another embodiment of the present invention, and FIG. 2B is a flowchart illustrating a touch control method according to another embodiment of the present invention.

In the present embodiment, the electronic device 200 has a touch unit 210, a press unit 220 and a processing module 230. Wherein, the press unit 220 is disposed under the touch unit 210, and is used for generating a pressing signal S, and the processing module 230 is electrically connected to the touch unit 210 and the press unit 220. When a determining unit 231 of the processing module 230 determines that the pressing signal S is received, the touch unit 210 is divided into a pressing area B and a sensing area D.

In the present embodiment, the touch unit 210 has a first module 211 and a second module 212, wherein the first module 211 is disposed corresponding to the pressing area B, and the second module 212 is disposed corresponding to the sensing area D. When the processing module 230 does not receive the pressing signal S, the first module 211 can sense a touch operation to generate a third sensing signal S3, and the second module 212 can sense a touch operation to generate a fourth sensing signal S4. When the processing module 230 receives the pressing signal S, the first module 211 cannot be actuated by the touch operation, and only the second module 212 can be actuated by the touch operation, so that the touch unit 210 is divided into the pressing area B and the sensing area D.

In detail, referring to steps S210-S250 of FIG. 2B, which is a flowchart of the touch control method of the present embodiment.

In the step S210, it is determined whether the processing module 230 receives the pressing signal S. If not, the step S220 is executed, and if yes, the step S230 is executed.

In the step S220, since the pressing signal S is not received, it is determined that the user only performs a touch operation on the touch unit 210. Now, when the user's finger moves on the touch unit 210, the first module 211 or the second module 212 of the touch unit 210 can be touched. Therefore, the first module 211 of the touch unit 210 generates the third sensing signal S3 or the second module 212 of the touch unit 210 generates the fourth sensing signal S4 according to a moving variation of a touch position of the user, and the processing module 230 receives the third sensing signal S3 or the fourth sensing signal S4 to generate a first cursor control signal T1. For example, the first cursor control signal T1 can be a cursor direction control signal.

In the step S230, the processing module 230 determines whether the fourth sensing signal S4 of the touch unit 210 is received, if not, the step S240 is executed, and if yes, the step S250 is executed.

In the step S240, when the processing module 230 receives the pressing signal S, the first module 211 disposed corresponding to the pressing area B cannot be actuated by the touch operation to generate the third sensing signal S3, and the second module 212 disposed corresponding to the sensing area D can be actuated by the touch operation to generate the fourth sensing signal S4. When the processing module 230 does not receive the fourth sensing signal S4, it represents that the user only presses the touch unit 210 (the pressing area B) to simply perform a press operation. Therefore; the processing module 230 receives the pressing signal S and generates a second cursor control signal T2. In the present embodiment, the second cursor control signal T2 can be a left key function signal or a right key function signal of a mouse, though the present invention is not limited thereto.

In the step S250, when the processing module 230 receives the fourth sensing signal S4, it represents that after the user presses the touch unit 210, the user again touches the sensing area D of the touch unit 210. Therefore, the processing module 230 receives the pressing signal S and the fourth sensing signal S4 generated by the sensing area D (the second module 212) to generate a third cursor control signal T3. As described in the aforementioned embodiment, the third cursor control signal T3 can be a window selecting signal, so that the user can perform a window selecting operation on the screen.

In summary, according to the electronic device and the touch control method of the present invention, when the processing module receives the pressing signal, an area of the touch unit is transformed into a pressing area, and since the pressing area cannot be actuated by the touch operation, a cursor control is not influenced. Moreover, the sensing area and the pressing area can be preset on the touch unit, or the first module and the second module corresponding to the pressing area and the sensing area are respectively configured on the touch unit. By such means, when the pressing signal is not received, a full region of the touch unit can sense the touch operation to generate the sensing signal. When the pressing signal is received, an area of the touch unit is transformed into the pressing area, and the pressing area cannot be actuated by the touch operation, while only the sensing area can be actuated by the touch operation. Compared to a conventional technique, application of a high-order multi-point touch unit and a high-order operation processing module is unnecessary, and changing of circuit designs of the touch unit and the processing module is also unnecessary, so that a production cost thereof can be reduced. Moreover, the pressing unit is disposed under the touch unit, so that the press unit does not occupy a configuration space of the touch unit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch control method, adapted to an electronic device including a processing module, a touch unit, and a press unit disposed under the touch unit, the touch control method comprising:
pressing an area of the touch unit to trigger the press unit to generate a pressing signal; and
transforming the area of the touch unit into a pressing area when the processing module receives the pressing signal.

2. The touch control method as claimed in claim 1, wherein when the processing module receives the pressing signal, the processing module divides the touch unit into a sensing area and the pressing area, wherein the sensing area of the touch unit is capable of being actuated by a touch operation, and the pressing area of the touch unit is incapable of being actuated by the touch operation.

3. The touch control method as claimed in claim 1, wherein the processing module has a determining unit used for determining whether the processing module receives the pressing signal.

4. The touch control method as claimed in claim 1, wherein when the processing module does not receive the pressing signal, the processing module receives a first sensing signal of the touch unit to generate a first cursor control signal.

5. The touch control method as claimed in claim 1, wherein the processing module receives the pressing signal to generate a second cursor control signal.

6. The touch control method as claimed in claim 2, wherein the processing module receives the pressing signal and a second sensing signal of the sensing area to generate a third cursor control signal.

7. The touch control method as claimed in claim 1, wherein the area of the touch unit is disposed corresponding to the press unit.

8. The touch control method as claimed in claim 2, wherein the touch unit has a first module and a second module, wherein the first module is disposed corresponding to the pressing area, and the second module is disposed corresponding to the sensing area, and when the processing module receives the pressing signal, only the second module is capable of being actuated by a touch operation.

9. The touch control method as claimed in claim 8, wherein when the processing module does not receive the pressing signal, the processing module receives a third sensing signal of the first module or a fourth sensing signal of the second module to generate a first cursor control signal.

10. The touch control method as claimed in claim 8, wherein the processing module receives the pressing signal and the fourth sensing signal of the second module to generate a third cursor control signal.

11. An electronic device, comprising:
a touch unit;
a press unit, disposed under the touch unit, for generating a pressing signal;
a processing module, electrically connected with the touch unit and the press unit, and when the processing module receiving the pressing signal, an area of the touch unit being transformed into a pressing area.

12. The electronic device as claimed in claim 11, wherein when the processing module receives the pressing signal, the processing module divides the touch unit into a sensing area and the pressing area, wherein the sensing area of the touch unit is capable of being actuated by a touch operation, and the pressing area of the touch unit is incapable of being actuated by the touch operation.

13. The electronic device as claimed in claim 11, wherein the processing module has a determining unit used for determining whether the processing module receives the pressing signal.

14. The electronic device as claimed in claim 11, wherein when the processing module does not receive the pressing signal, the processing module receives a first sensing signal of the touch unit to generate a first cursor control signal.

15. The electronic device as claimed in claim 11, wherein the processing module receives the pressing signal to generate a second cursor control signal.

16. The electronic device as claimed in claim 12, wherein the processing module receives the pressing signal and a second sensing signal of the sensing area to generate a third cursor control signal.

17. The electronic device as claimed in claim 12, wherein the area of the touch unit transformed into the pressing area is disposed corresponding to the press unit.

18. The electronic device as claimed in claim 12, wherein the touch unit has a first module and a second module, wherein the first module is disposed corresponding to the pressing area, and the second module is disposed corresponding to the sensing area, and when the processing module receives the pressing signal, only the second module is capable of being actuated by a touch operation.

19. The electronic device as claimed in claim 18, wherein when the processing module does not receive the pressing signal, the processing module receives a third sensing signal of the first module or a fourth sensing signal of the second module to generate a first cursor control signal.

20. The electronic device as claimed in claim 18, wherein the processing module receives the pressing signal and the fourth sensing signal of the second module to generate a third cursor control signal.
